(19) United States
(12) Patent Application Publication
(10) Pub. No.: US 2011/0188545 A1
(43) Pub. Date: Aug. 4, 2011

(54) DIRECT-SEQUENCE ULTRA-WIDEBAND TERMINAL DEVICE

(75) Inventor: Eun Yeong AN, Seoul (KR)

(73) Assignee: PANTECH CO., LTD., Seoul (KR)

(21) Appl. No.: 12/985,204

(22) Filed: Jan. 5, 2011

(30) Foreign Application Priority Data
Jan. 29, 2010 (KR) 10-2010-0008528

(51) Int. Cl. H04B 1/707

(52) U.S. Cl. 375/141; 375/146; 375/E01.002

(57) ABSTRACT

Provided is a Direct-Sequence Ultra-Wideband (DS-UWB) terminal device. A mobile communication terminal device using a DS-UWB scheme may simultaneously or sequentially transmit and receive a signal in a low-frequency band and a signal in a high-frequency band, and may simultaneously process the signals. Therefore, the DS-UWB scheme may be applied to a function division technique.

### CROSS-REFERENCE TO RELATED APPLICATION

This application claims priority from and the benefit under 35 U.S.C. §119(a) of Korean Patent Application No. 10-2010-0008528, filed on Jan. 29, 2010, which is hereby incorporated by reference for all purposes as if fully set forth herein.

### BACKGROUND

1. Field

Exemplary embodiments relate to a Direct-Sequence Ultra-Wideband (DS-UWB) terminal device.

2. Discussion of the Background

A DS-UWB system may use two bands, namely, a low-frequency band and a high-frequency band, and may form a plurality of piconet channels over different carrier wave is frequencies and diffusion codes. A piconet refers to a network with a single master and up to seven activated slave nodes.

However, in a conventional DS-UWB system, if a Binary Phase-Shift Keying (BPSK) modulation scheme is used during DS-UWB transmission, and if a diffusion code length L is equal to or less than 6, the same diffusion code may be used in all piconets. In other words, it is impossible to substantially form two or more piconets. If a 4-Binary Orthogonal Keying (4-BOK) modulation scheme is used, 2 and 12 is used as a diffusion code length L, so only a single piconet may be formed in the same area. In other words, it is impossible to form two or more piconets, and accordingly, the master may sequentially transmit data to a plurality of slave nodes, rather than simultaneously transmitting the data to the plurality of slave nodes. Thus, problems may occur if a DS-UWB technology is applied to a multimedia system design in a mobile communication terminal.

### SUMMARY

Exemplary embodiments of the present invention provide a Direct-Sequence Ultra-Wideband (DS-UWB) terminal device that may actively use a frequency band assigned for use of a UWB to improve a communication quality of a mobile terminal.

Additional features of the invention will be set forth in the description which follows, and in part will be apparent from the description, or may be learned by practice of the invention.

An exemplary embodiment of the present invention provides a DS-UWB terminal device, including an Rx signal generator to generate a low-frequency reception signal and a high-frequency reception signal from a reception signal received through a UWB transceiver; a signal is processor to process the generated low-frequency reception signal and the generated high-frequency reception signal, and to output a transmission signal; and a Tx signal generator to convert the transmission signal output from the signal processor and to generate a low-frequency transmission signal and a high-frequency transmission signal, wherein the UWB transceiver transmits the generated low-frequency transmission signal or the generated high-frequency transmission signal through one of a low-frequency transmission band and a high-frequency transmission band.

An exemplary embodiment of the present invention provides a DS-UWB system, including a master device to simultaneously or sequentially receive a low-frequency reception signal transmitted through a low-frequency band and a high-frequency reception signal transmitted through a high-frequency band if the master device is in a reception mode; and at least one slave device to transmit to the master device at least one of the low-frequency reception signal and the high-frequency reception signal, through the low-frequency band and the high-frequency band, respectively.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIGS. 1 to 7 are block diagrams illustrating Direct-Sequence Ultra-Wideband (DS-UWB) terminal devices according to exemplary embodiments of the present invention.

FIG. 8 is a block diagram illustrating a DS-UWB system according to an exemplary embodiment of the present invention.

FIGS. 9 to 11 illustrate examples of DS-UWB systems according to exemplary embodiments of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

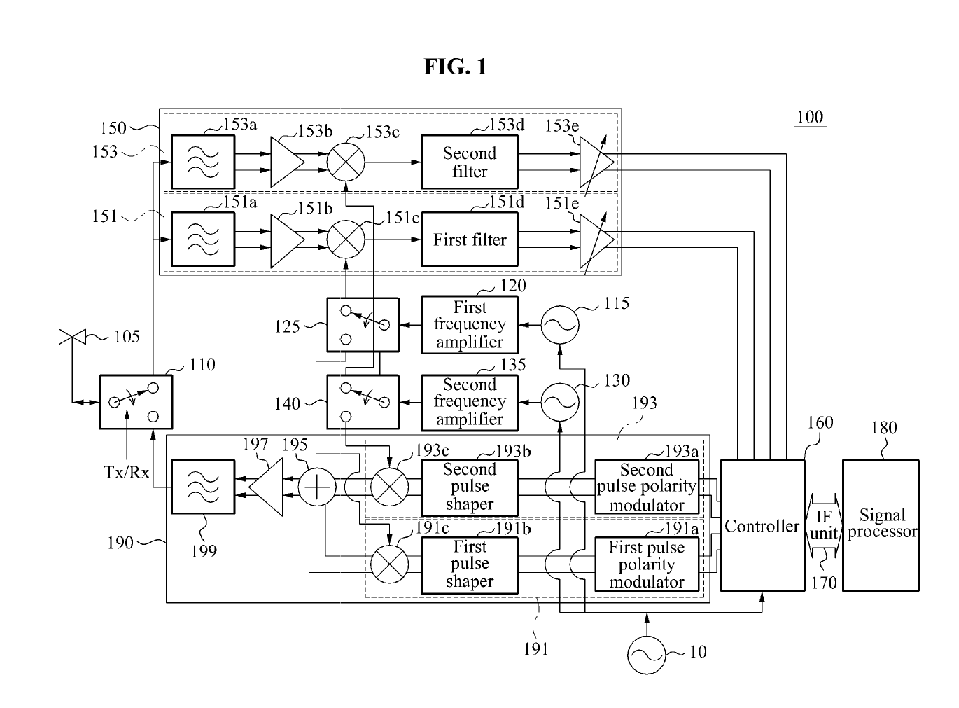

FIG. 1 is a block diagram of a Direct-Sequence Ultra-Wideband (DS-UWB) terminal device 100 according to an exemplary embodiment of the present invention.

The DS-UWB terminal device 100 may include a UWB transceiver 105, a first switch 110, a first signal converter 115, a first frequency amplifier 120, a second switch 125, a second signal converter 130, a second frequency amplifier 135, a third switch 140, an Rx signal generator 150, a controller 160, an interface (IF) unit 170, a signal processor 180, and a Tx signal generator 190.

The UWB transceiver 105 (hereinafter, referred to as the “transceiver”) may is receive a signal from at least one slave device using a UWB scheme, and may be, for example, an antenna. The transceiver 105 may simultaneously or individually transmit and receive a signal in a low-frequency band and a signal in a high-frequency band.

If the DS-UWB terminal device 100 is in a reception mode, the first switch 110 may connect the transceiver 105 and the Rx signal generator 150 under the control of the controller 160 so that a reception signal path may be provided. If the DS-UWB terminal device 100 is in a transmission mode, the first switch 110 may connect the transceiver 105 and the Tx signal generator 190 under the control of the controller 160 so that a transmission signal path may be provided.

The first signal converter 115 may generate a pulse of a weight signal to be applied to a signal in a low-frequency band received from the controller 160, and may convert a frequency of the weight signal. The weight signal may be used to convert the received signal in the low-frequency band to a signal in a desired frequency band. Also, the first signal converter 115 may generate a pulse of a weight signal to be applied to a signal in a low-frequency band, which is received from the controller 160 and is to be transmitted, and may convert a frequency of the weight signal.

The first frequency amplifier 120 may amplify the frequency of the weight signal output from the first signal converter 115.

In the reception mode, the second switch 125 may provide a path between the first frequency amplifier 120 and a first multiplier 151c of the Rx signal generator 150. In the transmission mode, the second switch 125 may provide a path between the first frequency amplifier 120 and a third multiplier 191c of the Tx signal generator 190. Accordingly, in the reception mode, the second switch 125 may output the frequency amplified by the first frequency is amplifier 120 to the first multiplier 151c. Here, the amplified frequency may be a weight signal.

The second signal converter 130 may generate a pulse of a weight signal to be applied to a signal in a high-frequency band received from the controller 160, and may convert a frequency of the weight signal. The weight signal may be used to convert the received signal in the high-frequency band to a signal in a desired frequency band. Also, the second signal converter 130 may generate a pulse of a weight signal to be applied to a signal in a high-frequency band which is received from the controller 160 and is to be transmitted, and may convert a frequency of the weight signal.

The second frequency amplifier 135 may amplify the frequency of the weight signal output from the second signal converter 130.

In the reception mode, the third switch 140 may provide a path between the second frequency amplifier 135 and a second multiplier 153c of the Rx signal generator 150. In the transmission mode, the third switch 140 may provide a path between the second frequency amplifier 135 and a fourth multiplier 193c of the Tx signal generator 190. Accordingly, in the reception mode, the third switch 140 may output the frequency amplified by the second frequency amplifier 135 to the second multiplier 153c. Here, the amplified frequency may be a weight signal. Further, the DS-UWB terminal device 100 may include a third signal converter 10 connected between the controller 160 and the first and second signal converters 115 and 130 to generate a pulse of a weight signal to be applied to a signal inputted to or outputted from the controller 160.

The Rx signal generator 150 may generate a low-frequency reception signal and a high-frequency reception signal from a signal received through the transceiver 105. The Rx signal generator 150 may include an Rx low-frequency signal generator 151 and an Rx high-frequency signal generator 153.

The Rx low-frequency signal generator 151 of the Rx signal generator 150 may filter out, or pass, a low-frequency band from the received signal, and may generate the low-frequency reception signal. The Rx low-frequency signal generator 151 may include a low-frequency filter 151a, a first amplifier 151b, the first multiplier 151c, a first filter 151d, and a first Automatic Gain Controller (AGC) 151e.

The low-frequency filter 151a may filter out, or pass, a signal of a predetermined low-frequency band, namely, a low-frequency reception signal from the signal received through the transceiver 105, and may output the filtered low-frequency reception signal. The low-frequency filter 151a may be, for example, a Band Rejection Filter (BRF).

The first amplifier 151b may amplify the filtered low-frequency reception signal. The first amplifier 151b may be a Low Noise Amplifier (LNA), which is used to amplify a received signal by reducing a noise of the signal.

The first multiplier 151c may multiply the amplified low-frequency reception signal by a weight, and may convert the amplified low-frequency reception signal to a signal of a set frequency band. Here, the weight may be the frequency amplified by the first frequency amplifier 120.

The first filter 151d may be a Low-Pass Filter (LPF) or a Band-Pass Filter (BPF), to filter out, or pass, the low-frequency reception signal output from the first multiplier 151c. The first AGC 151e may increase an amplification rate of the low-frequency reception signal filtered by the first filter 151d.

The Rx high-frequency signal generator 153 of the Rx signal generator 150 may filter out, or pass, a high-frequency band from the received signal, and may generate the high-frequency reception signal. The Rx high-frequency signal generator 153 may include a high-frequency filter 153a, a second amplifier 153b, a second multiplier 153c, a second filter 153d, and a second AGC 153e.

The high-frequency filter 153a may filter out, or pass, a signal of a high-frequency band, namely, a high-frequency reception signal from the signal received through the transceiver 105, and may output the filtered high-frequency reception signal. The high-frequency filter 153a may be, for example, a BRF.

The second amplifier 153b may amplify the filtered high-frequency reception signal.

The second multiplier 153c may multiply the amplified high-frequency reception signal by a weight, and may convert the amplified high-frequency reception signal to a signal of a set frequency band. Here, the weight may correspond to the frequency amplified by the second frequency amplifier 135.

The second filter 153d may be a LPF or a BPF to filter out, or pass, the converted high-frequency reception signal output from the second multiplier 153c. The second AGC 153e may increase an amplification rate of the high-frequency reception signal filtered by the second filter 153d.

The controller 160 may convert one of the low-frequency reception signal and the high-frequency reception signal which are respectively output from the first AGC 151e and the second AGC 153e to a digital signal, and may perform control of a Radio Frequency (RF), a data recovery, or processing of data in a baseband. Also, the controller 160 may control operations of the DS-UWB terminal device 100. The controller 160 may be a main Central Processing Unit (CPU).

The IF unit 170 may interface between the controller 160 and the signal processor 180. The IF unit 170 may interactively transmit data or signals between the controller 160 and the signal processor 180 at high-speed.

The signal processor 180 may process the generated low-frequency reception signal or the generated high-frequency reception signal on characteristics of the signals. For example, if an audio signal is received in a low-frequency band, the signal processor 180 may process the audio signal to output an audio. If a video signal is received in a high-frequency band, the signal processor 180 may process the video signal to display a video.

In the transmission mode, the signal processor 180 may generate a transmission signal and output the generated transmission signal to a slave device using the UWB scheme. Here, the transmission signal may include at least one of a signal in a low-frequency band (i.e., a low-frequency transmission signal) and a signal in a high-frequency band (i.e., a high-frequency transmission signal).

The Tx signal generator 190 may convert the transmission signal output from the signal processor 180, and may generate a low-frequency transmission signal and a high-frequency transmission signal. The Tx signal generator 190 may include a Tx low-frequency signal generator 191, a Tx high-frequency signal generator 193, an adder 195, a power amplifier 197, and a transmission filter 199.

The Tx low-frequency signal generator 191 may convert the transmission signal from the signal processor 180, and may generate the low-frequency transmission signal to be transmitted through the low-frequency band. The Tx low-frequency signal generator 191 may include a first pulse polarity modulator 191a, a first pulse shaper 191b, and a third multiplier 191c.

The first pulse polarity modulator 191a may modulate a pulse polarity of the low-frequency transmission signal received from the signal processor 180 via the IF unit 170 and the controller 160. The first pulse shaper 191b may perform pulse shaping on the low-frequency transmission signal output from the first pulse polarity modulator 191a.

The third multiplier 191c may multiply the low-frequency transmission signal output from the first pulse shaper 191b by a weight received through the third switch 140 so that the low-frequency transmission signal may be weighted.

The Tx high-frequency signal generator 193 may convert the transmission signal from the signal processor 180, and may generate the high-frequency transmission signal to be transmitted through the high-frequency band. The Tx high-frequency signal generator 193 may include a second pulse polarity modulator 193a, a second pulse shaper 193b, and a fourth multiplier 193c.

The second pulse polarity modulator 193a may modulate a pulse polarity of the high-frequency transmission signal received from the signal processor 180 via the IF unit 170 and the controller 160. The second pulse shaper 193b may perform pulse shaping on the high-frequency transmission signal output from the second pulse polarity modulator 193a.

The fourth multiplier 193c may multiply the high-frequency transmission signal output from the first pulse shaper 193b by a weight received through the third switch 140 so that the high-frequency transmission signal may be weighted.

The adder 195 may add the weighted low-frequency transmission signal and the weighted high-frequency transmission signal. The power amplifier 197 may amplify the signal output from the adder 195.

The transmission filter 199 may filter out, or pass, a signal of an output frequency band from the signal amplified by the power amplifier 197. For example, if a low-frequency band is set as an output frequency band, the transmission filter 199 may filter out, or pass, the low-frequency transmission signal from the processed transmission signal from the signal processor 180. If a high-frequency band is set as an output frequency band, the transmission filter 199 may filter out, or pass, the high-frequency transmission signal from the processed transmission signal from the signal processor 180. The transmission filter 199 may be an emission limit filter.

The power amplifier 197, the transmission filter 199, and the transceiver 105 may process a wideband signal, respectively, as shown in FIG. 1. For example, the transmission filter 199 may be any device enabling wideband filtering to filter out, or pass, signals in both the low-frequency band and the high-frequency band.

The transceiver 105 may transmit at least one of the high-frequency transmission signal and the low-frequency transmission signal which are generated by the Tx signal generator 190, to at least one slave device through one of the high-frequency transmission band and the low-frequency transmission band, respectively.

The DS-UWB terminal device 100 of FIG. 1 may simultaneously process both of the two frequency bands, namely, the low-frequency band and the high-frequency band. In the reception mode, the DS-UWB terminal device 100 may divide a received signal into two signals in the two frequency bands, and may transfer the divided signals to the signal processor 180 through two signal paths. In the transmission mode, the DS-UWB terminal device 100 may convert a signal in a low-frequency band and a signal in a high-frequency band and may simultaneously transmit the two converted signals to the at least one slave device.

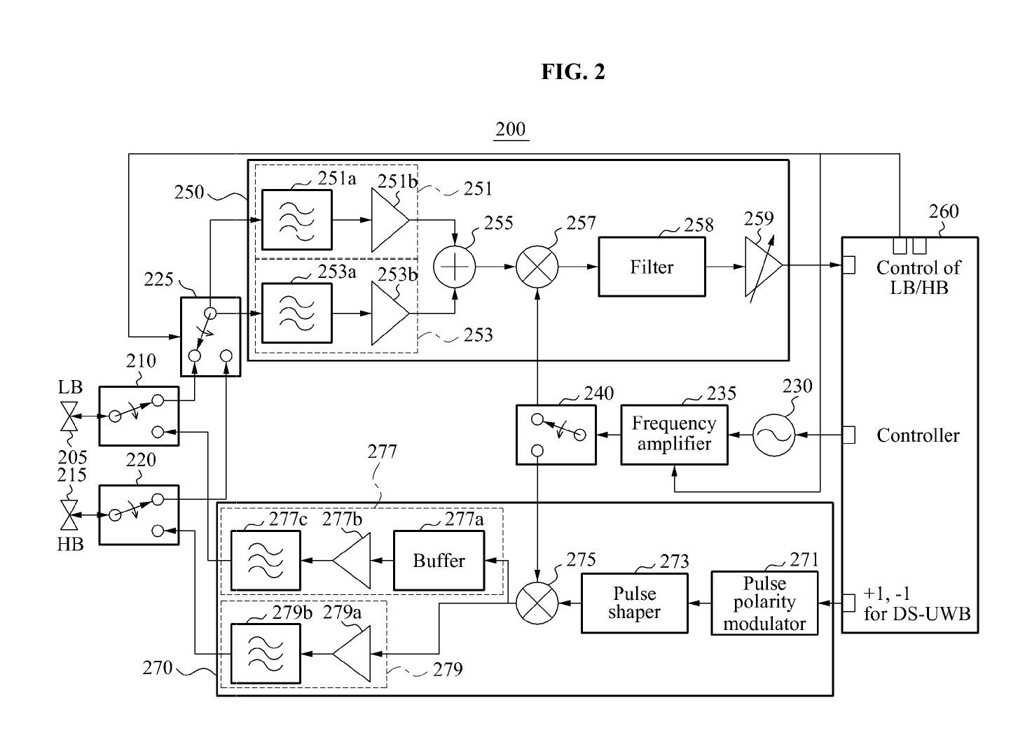

FIG. 2 is a block diagram of a DS-UWB terminal device 200 according to an exemplary embodiment of the present invention.

The DS-UWB terminal device 200 of FIG. 2 may include a low-frequency transceiver 205, a first switch 210, a high-frequency transceiver 215, a second switch 220, a third switch 225, a signal converter 230, a frequency amplifier 235, a fourth switch 240, an Rx signal generator 250, a controller 260, and a Tx signal generator 270.

The low-frequency transceiver 205 may receive a reception signal of a low-frequency band from at least one slave device, and may transmit a transmission signal of the low-frequency band to the at least one slave device using the UWB scheme. The low-frequency transceiver 205 may be, for example, an antenna.

If the DS-UWB terminal device 200 is in a reception mode, the first switch 210 may connect the low-frequency transceiver 205 and an Rx low-frequency signal generator 251 of the Rx signal generator 250, and may transfer the reception signal of the low-frequency band to the Rx low-frequency signal generator 251. If the DS-UWB terminal device 200 is in the transmission mode, the first switch 210 may connect the low-frequency transceiver 205 and a Tx low-frequency signal generator 277 of the Tx signal generator 270, and may transfer the transmission signal of the low-frequency band to the low-frequency transceiver 205.

The high-frequency transceiver 215 may receive a reception signal of a high-frequency band from at least one slave device, and may transmit a transmission signal of the high-frequency band to the at least one slave device using the UWB scheme. The high-frequency transceiver 215 may be, for example, an antenna.

In the reception mode, the second switch 220 may connect the high-frequency transceiver 215 and an Rx high-frequency signal generator 253 of the Rx signal generator 250, and may transfer the reception signal of the high-frequency band to the Rx high-frequency signal generator 253. In the transmission mode, the second switch 220 may connect the high-frequency transceiver 215 and a Tx high-frequency signal generator 279, and may transfer the transmission signal of the high-frequency band to the high-frequency transceiver 215.

The third switch 225 may connect a path between the third switch 225 and the first switch 210, or a path between the third switch 225 and the second switch 220, and may receive a low-frequency reception signal or a high-frequency reception signal.

In the reception mode, the signal converter 230 may generate a pulse of a weight signal to be applied to the low-frequency reception signal or the high-frequency reception signal, and may convert a frequency of the weight signal. In the transmission mode, the signal converter 230 may generate a pulse of a weight signal to be applied to the low-frequency transmission signal or the high-frequency transmission signal, and may convert a frequency of the weight signal. The low-frequency reception signal, the high-frequency reception signal, the low-frequency transmission signal, and the high-frequency transmission signal may be received from the controller 260.

The frequency amplifier 235 may amplify the weight signal, of which the frequency is converted by the signal converter 230, and may generate a frequency.

In the reception mode, the fourth switch 240 may provide a path between the frequency amplifier 235, and a first multiplier 257 of the Rx signal generator 250. In the transmission mode, the fourth switch 240 may provide a path between the frequency amplifier 235, and a second multiplier 275 of the Tx signal generator 270. Accordingly, the fourth switch 240 may output the frequency amplified by the frequency amplifier 235 to the first multiplier 257 or the second multiplier 275 depending on an operating mode of the DS-UWB terminal device 200. Here, the amplified frequency may be used as a weight signal.

The Rx signal generator 250 may generate the low-frequency reception signal and the high-frequency reception signal from a signal received through the low-frequency transceiver 205 or the high-frequency transceiver 215. The Rx signal generator 250 includes the Rx low-frequency signal generator 251, the Rx high-frequency signal generator 253, an adder 255, the first multiplier 257, a filter 258, and an AGC 259.

The Rx low-frequency signal generator 251 may include a low-frequency filter 251a, and a first amplifier 251b. The low-frequency filter 251a may filter out, or pass, the low-frequency reception signal from a signal received through the low-frequency transceiver 205, the first switch 210, and the third switch 225. The first amplifier 251b may amplify the filtered low-frequency reception signal.

The Rx high-frequency signal generator 253 may include a high-frequency filter 253a and a second amplifier 253b. The high-frequency filter 253a may filter out, or pass, the high-frequency reception signal from a signal received through the high-frequency transceiver 215, the second switch 220, and the third switch 225. The second amplifier 253b may amplify the filtered high-frequency reception signal. The low-frequency filter 251a and the high-frequency filter 253a may be, for example, BRFs, and the first amplifier 251b and the second amplifier 253b may be, for example, LNAs.

The adder 255 may add and output the low-frequency reception signal amplified by the first amplifier 251b and the high-frequency reception signal amplified by the second amplifier 253b, and may output a resulting signal.

The first multiplier 257 may multiply the signal output from the adder 255 by a weight, and may convert the signal output from the adder 255 to a reception signal of a set frequency band. The weight may be the signal generated by the frequency amplifier 235.

The filter 258 may be an LPF or a BPF, to filter out, or pass, the converted reception signal output from the first multiplier 257. The AGC 259 may increase an amplification rate of the reception signal filtered by the filter 258.

The controller 260 may be substantially the same as or similar to the controller 160 of FIG. 1. For example, the controller 260 may control the Tx signal generator 270 to convert the reception signal output from the AGC 259 into a digital signal, and to convert a transmission signal output from a signal processor (not shown) into a signal of a set frequency band. Here, the reception signal output from the AGC 259 may be a sum of the low-frequency reception signal and the high-frequency reception signal.

The Tx signal generator 270 may convert a transmission signal to be transmitted to at least one slave device, and may generate a low-frequency transmission signal and a high-frequency transmission signal. The Tx signal generator 270 may include a pulse polarity modulator 271, a pulse shaper 273, a second multiplier 275, the Tx low-frequency signal generator 277, and the Tx high-frequency signal generator 279.

The pulse polarity modulator 271 may modulate a pulse polarity of the transmission signal received from the controller 260. The pulse shaper 273 may perform pulse shaping on the transmission signal output from the pulse polarity modulator 271.

The second multiplier 275 may multiply the transmission signal output from the pulse shaper 273 by a weight signal received through the fourth switch 240. The weight may be the signal generated by the frequency amplifier 235. Accordingly, a transmission signal of a desired band may be generated. The second multiplier 275 may demultiplex the weighted transmission signal, so that the weighted transmission signal may be divided into the low-frequency transmission signal and the high-frequency transmission signal. The second multiplier 275 may output the low-frequency transmission signal and the high-frequency transmission signal to the Tx low-frequency signal generator 277 and the Tx high-frequency signal generator 279, respectively.

The Tx low-frequency signal generator 277 may temporarily store the low-frequency transmission signal output from the second multiplier 275, and may filter out, or pass, a signal of an output low-frequency band from the low-frequency transmission signal. The Tx low-frequency signal generator 277 may include a buffer 277a, a first power amplifier 277b, and a first transmission filter 277c.

The buffer 277a may temporarily store the low-frequency transmission signal output from the second multiplier 275. The buffer 277a may be used to implement a high-frequency signal delay circuit having a band between 3 GHz and 10 GHz, and to synchronize transmission timing of the low-frequency transmission signal and the high-frequency transmission signal to be respectively transmitted to the transceivers 205 and 215 through a low-frequency path and a high-frequency path.

The first power amplifier 277b may amplify the low-frequency transmission signal output from the buffer 277a. The first transmission filter 277c may filter out, or pass, a signal of an output low-frequency band from the amplified low-frequency transmission signal, and may output the filtered signal to the first switch 210. The first transmission filter 277c may be an emission limit filter.

The Tx high-frequency signal generator 279 may filter out, or pass, a signal of an output high-frequency band from the high-frequency transmission signal output from the second multiplier 275. The Tx high-frequency signal generator 279 may include a second power amplifier 279a and a second transmission filter 279b.

The second power amplifier 279a may amplify the high-frequency transmission signal output from the second multiplier 275. The second transmission filter 279b may filter out, or pass, a signal of an output high-frequency band from the amplified high-frequency transmission signal, and may output the filtered signal to the second switch 220. The second transmission filter 279b may be an emission limit filter.

The low-frequency transceiver 205 may transmit the signal output from the first transmission filter 277c to at least one slave device through the output low-frequency band. Also, the high-frequency transceiver 215 may transmit the signal output from the second transmission filter 279b to at least one slave device through the output high-frequency band.

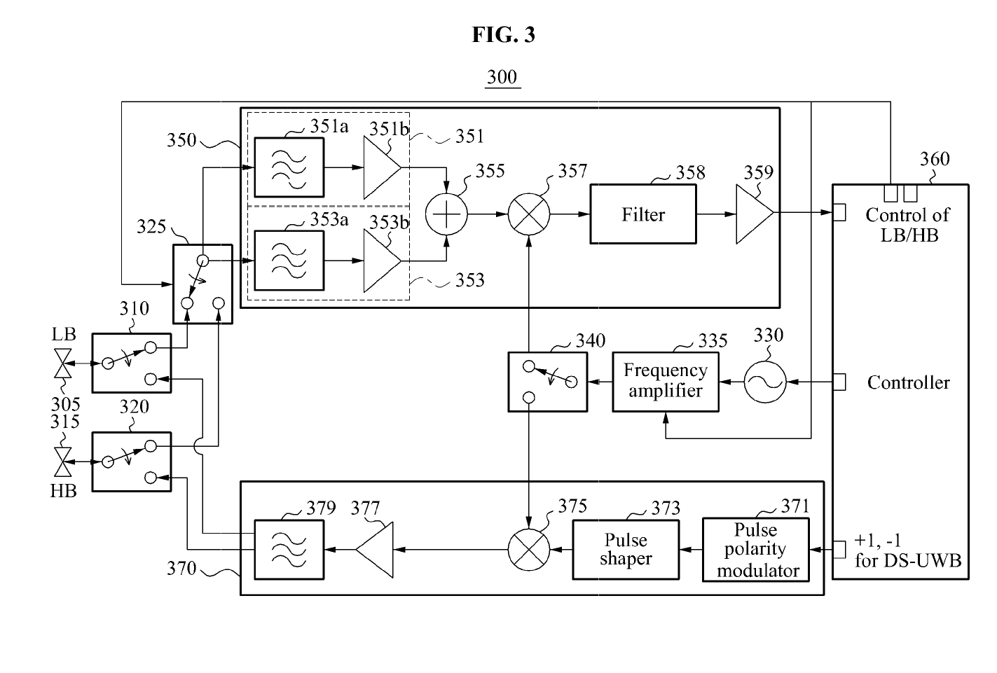

FIG. 3 is a block diagram of a DS-UWB terminal device 300 according to an exemplary embodiment of the present invention.

The DS-UWB terminal device 300 of FIG. 3 may include a low-frequency transceiver 305, a first switch 310, a high-frequency transceiver 315, a second switch 320, a third switch 325, a signal converter 330, a frequency amplifier 335, a fourth switch 340, an Rx signal generator 350, a controller 360, and a Tx signal generator 370.

The low-frequency transceiver 305, the first switch 310, the high-frequency transceiver 315, the second switch 320, the third switch 325, the signal converter 330, the frequency amplifier 335, the fourth switch 340, the Rx signal generator 350 and the controller 360 as shown in FIG. 3 may be, respectively, substantially the same as or similar to the low-frequency transceiver 205, the first switch 210, the high-frequency transceiver 215, the second switch 220, the third switch 225, the signal converter 230, the frequency amplifier 235, the fourth switch 240, the Rx signal generator 250, and the controller 260 as shown in FIG. 2. Accordingly, additional descriptions thereof will be omitted herein.

Referring to FIG. 3, the Tx signal generator 370 may include a pulse polarity modulator 371, a pulse shaper 373, a second multiplier 375, a power amplifier 377, and a wideband transmission filter 379. The power amplifier 377 and the wideband transmission filter 379 may process a wideband signal. In other words, the Tx signal generator 370 may process signals in both a low-frequency band and a high-frequency band.

The pulse polarity modulator 371 may modulate a pulse polarity of the transmission signal received from the controller 360. Here, the transmission signal may be either a low-frequency transmission signal or a high-frequency transmission signal.

The pulse shaper 373 may perform pulse shaping on the transmission signal output from the pulse polarity modulator 371.

The second multiplier 375 may multiply the transmission signal output from the pulse shaper 373 by a weight signal received through the fourth switch 340 so that the transmission signal may be weighted. Accordingly, it is possible to generate a transmission signal in a desired band.

The power amplifier 377 may amplify the transmission signal output from the second multiplier 375.

The wideband transmission filter 379 may filter out, or pass, a signal of an output frequency band from the amplified transmission signal, and may output a signal of an output low-frequency band or a signal of an output high-frequency band. For example, if a low-frequency transmission signal is amplified and if a low-frequency band is set as an output frequency band by the controller 360, the wideband transmission filter 379 may filter out, or pass, the amplified low-frequency transmission signal. The wideband transmission filter 379 may be an emission limit filter.

The low-frequency transceiver 305 may transmit, to at least one slave device, the signal of the output low-frequency band output from the wideband transmission filter 379. The high-frequency transceiver 315 may transmit, to the at least one slave device, the signal of the output high-frequency band output from the wideband transmission filter 379. Here, the signal of the output low-frequency band and the signal of the output high-frequency band may be the low-frequency transmission signal and the high-frequency transmission signal, respectively.

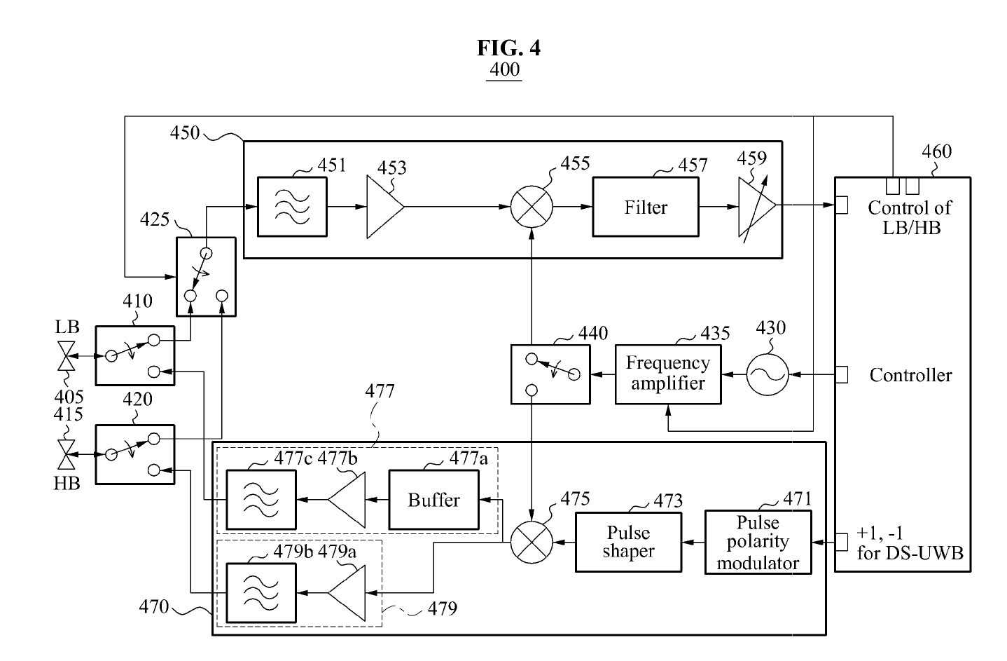

FIG. 4 is a block diagram of a DS-UWB terminal device 400 according to an exemplary embodiment of the present invention.

The DS-UWB terminal device 400 of FIG. 4 may include a low-frequency transceiver 405, a first switch 410, a high-frequency transceiver 415, a second switch 420, a third switch 425, a signal converter 430, a frequency amplifier 435, a fourth switch 440, an Rx signal generator 450, a controller 460, and a Tx signal generator 470.

The low-frequency transceiver 405, the first switch 410, the high-frequency transceiver 415, the second switch 420, the third switch 425, the signal converter 430, the frequency amplifier 435, the fourth switch 440, the controller 460, and the Tx signal generator 470 as shown in FIG. 4 may be substantially the same as or similar to the low-frequency transceiver 205, the first switch 210, the high-frequency transceiver 215, the second switch 220, the third switch 225, the signal converter 230, the frequency amplifier 235, the fourth switch 240, the controller 260, and the Tx signal generator 270 as shown in FIG. 2, respectively. Accordingly, additional descriptions thereof will be omitted herein.

Referring to FIG. 4, the Rx signal generator 450 may include a wideband reception filter 451, an amplifier 453, a first multiplier 455, a filter 457, and an AGC 459. The wideband reception filter 451 and the amplifier 453 may process a wideband signal.

The wideband reception filter 451 may filter out, or pass, a low-frequency reception signal and a high-frequency reception signal from a signal received through the low-frequency transceiver 405 and the high-frequency transceiver 415. For example, the wideband reception filter 451 may filter out, or pass, a signal in a band between 3 GHz and 10 GHz. The amplifier 453 may amplify the reception signal output from the wideband reception filter 451, that is, amplify either the low-frequency reception signal or the high-frequency reception signal. The wideband reception filter 451 and the amplifier 453 may be, for example, a BRF, and an LNA, respectively.

The first multiplier 455 may multiply the reception signal output from the amplifier 453 by a weight, and may convert the reception signal to a reception signal of a set frequency band. Here, the weight may be a signal generated by the frequency amplifier 435.

The filter 457 may be, for example, a LPF or a BPF, to filter out, or pass, the converted reception signal output from the first multiplier 455. The AGC 459 may increase an amplification rate of the reception signal filtered by the filter 457. The controller 460 may be substantially the same as or similar to the controllers 160, 260, and 360 as described above, and accordingly, additional descriptions thereof will be omitted herein.

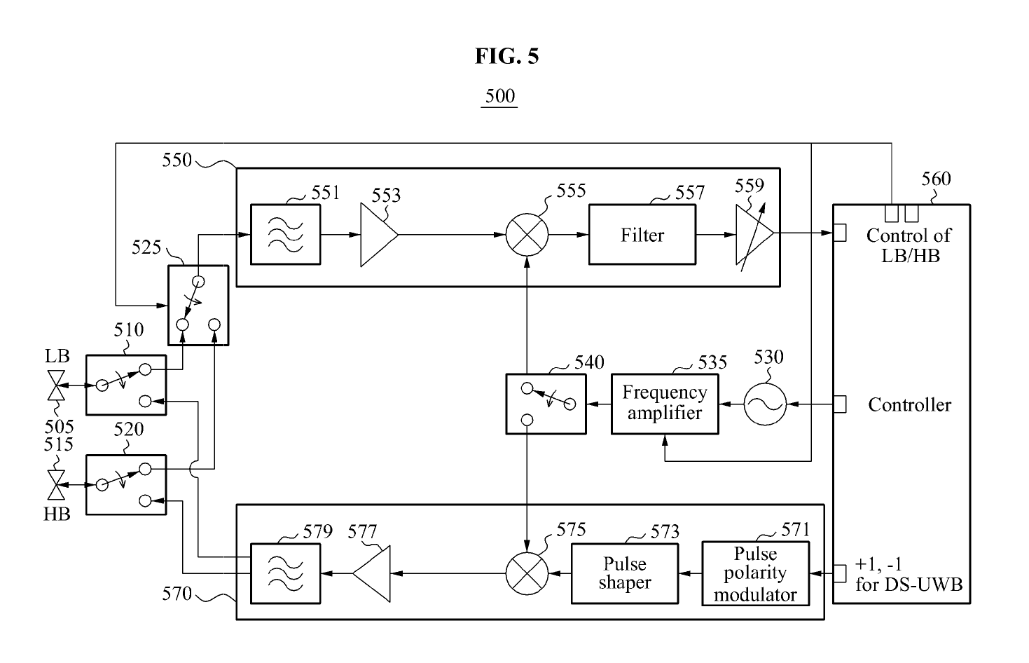

FIG. 5 is a block diagram of a DS-UWB terminal device 500 according to an exemplary embodiment of the present invention.

The DS-UWB terminal device 500 of FIG. 5 may include a low-frequency transceiver 505, a first switch 510, a high-frequency transceiver 515, a second switch 520, a third switch 525, a signal converter 530, a frequency amplifier 535, a fourth switch 540, an Rx signal generator 550, a controller 560, and a Tx signal generator 570.

The low-frequency transceiver 505, the first switch 510, the high-frequency transceiver 515, the second switch 520, the third switch 525, the signal converter 530, the frequency amplifier 535, the fourth switch 540, and the controller 560 as shown in FIG. 5 may be substantially the same as or similar to the low-frequency transceiver 205, the first switch 210, the high-frequency transceiver 215, the second switch 220, the third switch 225, the signal converter 230, the frequency amplifier 235, the fourth switch 240, and the controller 260 as shown in FIG. 2, respectively. Accordingly, additional descriptions thereof will be omitted herein.

Also, the Rx signal generator 550 of FIG. 5 may be substantially the same as or similar to the Rx signal generator 450 of FIG. 4, and the Tx signal generator 570 of FIG. 5 may be substantially the same as or similar to the Tx signal generator 370 of FIG. 3, and accordingly, additional descriptions thereof will be omitted herein. Specifically, a wideband reception filter 551 and an amplifier 553 of the Rx signal generator 550, and a power amplifier 577 and a transmission filter 579 of the Tx signal generator 570 may process a wideband signal so as to process signals in both the low-frequency band and the high-frequency band.

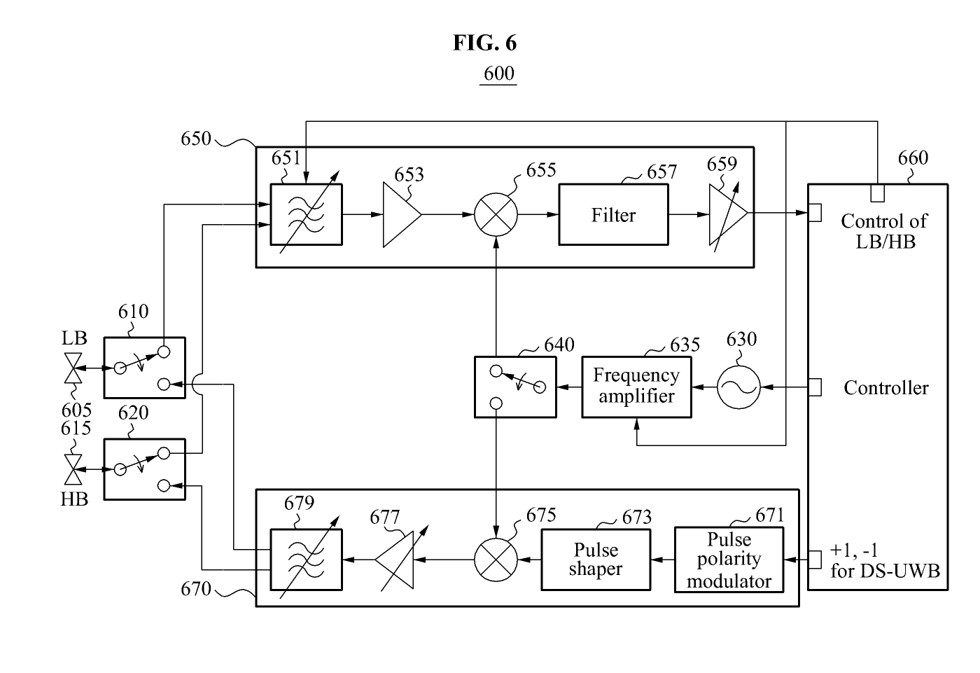

FIG. 6 is a block diagram of a DS-UWB terminal device 600 according to an exemplary embodiment of the present invention.

The DS-UWB terminal device 600 of FIG. 6 may include a low-frequency transceiver 605, a first switch 610, a high-frequency transceiver 615, a second switch 620, a signal converter 630, a frequency amplifier 635, a third switch 640, an Rx signal generator 650, a controller 660, and a Tx signal generator 670.

The low-frequency transceiver 605, the first switch 610, the high-frequency transceiver 615, the second switch 620, the signal converter 630, the frequency amplifier 635, the third switch 640, and the controller 660 as shown in FIG. 6 may be respectively, substantially the same as or similar to the low-frequency transceiver 505, the first switch 510, the high-frequency transceiver 515, the second switch 520, the signal converter 530, the frequency amplifier 535, the fourth switch 540, and the controller 560 as shown in FIG. 5. Accordingly, additional descriptions thereof will be omitted herein.

The Rx signal generator 650 may include a variable reception filter 651, a reception amplifier 653, a first multiplier 655, a filter 657, and an AGC 659.

The variable reception filter 651 may vary a frequency band to be filtered, and may filter out, or pass, a low-frequency reception signal and a high-frequency reception signal from signals received through the low-frequency transceiver 605 and the high-frequency transceiver 615. The controller 660 may perform time-sharing to determine whether a currently received signal is a low-frequency reception signal or a high-frequency reception signal. If the low-frequency reception signal is determined to be currently received, the controller 660 may control the variable reception filter 651 to be connected to the first switch 610. Alternatively, if the high-frequency reception signal is determined to be currently received, the controller 660 may control the variable reception filter 651 to be connected to the second switch 620. Accordingly, the variable reception filter 651 may identify which one of the low-frequency reception signal and the high-frequency reception signal is received.

The reception amplifier 653 may amplify the reception signal received from the variable reception filter 651, that is, amplify either the low-frequency reception signal or the high-frequency reception signal. The first multiplier 655 may multiply the amplified reception signal output from the reception amplifier 653 by a weight, and may convert the amplified reception signal to a reception signal of a set frequency band. Here, the weight may be a signal generated by the frequency amplifier 635.

The filter 657 may be, for example, an LPF or a BPF to filter out, or pass, the converted reception signal output from the first multiplier 655. The AGC 659 may increase an amplification rate of the reception signal filtered by the filter 657. The controller 660 may be substantially the same as or similar to the controllers 160, 260, and 360 as described above, and accordingly, additional descriptions thereof will be omitted herein.

The Tx signal generator 670 may include a pulse polarity modulator 671, a pulse shaper 673, a second multiplier 675, a variable power amplifier 677, and a variable transmission filter 679.

The pulse polarity modulator 671 may modulate a pulse polarity of the transmission signal received from the controller 660. Here, the transmission signal may be either a low-frequency transmission signal or a high-frequency transmission signal.

The pulse shaper 673 may perform pulse shaping on the transmission signal output from the pulse polarity modulator 671.

The second multiplier 675 may multiply the transmission signal output from the pulse shaper 673 by a weight signal received through the third switch 640, so that the transmission signal may be weighted. Accordingly, it is possible to generate a transmission signal in a desired band.

The variable power amplifier 677 may variably amplify the transmission signal output from the second multiplier 675, and may output the low-frequency transmission signal or the high-frequency transmission signal. For example, the variable power amplifier 677 may vary the high-frequency transmission signal using a power set corresponding to the high-frequency band. The variable power amplifier 677 may process the low-frequency transmission signal in a same or similar manner as the high-frequency transmission signal.

The variable transmission filter 679 may vary a frequency band to be filtered, and may filter out, or pass, a signal of an output low-frequency band or a signal of an output high-frequency band from the amplified transmission signal received from the variable power amplifier 677.

In the transmission mode, the controller 660 may control the low-frequency transceiver 605, the first switch 610, the high-frequency transceiver 615, and the second switch 620 so that the high-frequency transmission signal and the low-frequency transmission signal may be sequentially transmitted to at least one slave device corresponding to the high-frequency band and to at least one slave device corresponding to the low-frequency band, respectively, using the variable power amplifier 677 and the variable transmission filter 679. In this instance, at least one of the two slave devices may perform synchronization between the received high-frequency transmission signal and the received low-frequency transmission signal. To prevent the synchronization between the two transmission signals from being misaligned, the controller 660 may add data or a packet to a termination signal of the output low-frequency band or the output high-frequency band. Here, the data or packet may be used to identify the termination signal.

For example, if a low-frequency transmission signal is transmitted to a slave device prior to a high-frequency transmission signal, the controller 660 may add a packet or data to a termination portion of the low-frequency transmission signal to indicate that the low-frequency transmission signal is the last signal transmitted in a corresponding band. Thus, it is possible to ascertain a time at which the low-frequency transmission signal is transmitted, thereby reducing a time gap between the low-frequency transmission signal and the high-frequency transmission signal to be transmitted after the low-frequency transmission signal. Alternatively, the controller 660 may reduce a switching time between a high-frequency band and a low-frequency band, thereby synchronizing the received high-frequency transmission signal and the received low-frequency transmission signal. The switching time may be, for example, a time used to periodically connect the first switch 610 and the second switch 620.

Also, the slave device may control the synchronization between the received low-frequency transmission signal and the received high-frequency transmission signal by a dummy time gap. For example, if a speaker slave device receives a low-frequency transmission signal, e.g., an audio signal, after a display slave device for receiving a low-frequency transmission signal receives a high-frequency transmission signal, e.g., a video signal, the display slave device or the speaker slave device may delay the video signal or the audio signal so that the video signal and the audio signal may be synchronized with each other.

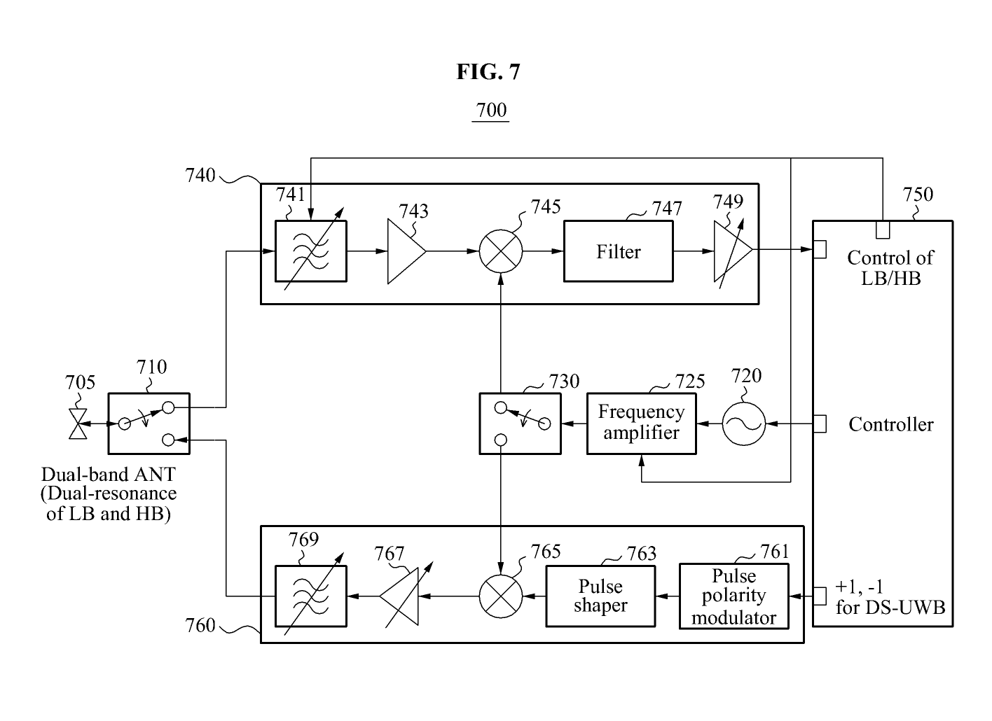

FIG. 7 is a block diagram of a DS-UWB terminal device 700 according to an exemplary embodiment of the present invention.

The DS-UWB terminal device 700 of FIG. 7 may include a transceiver 705, a first switch 710, a signal converter 720, a frequency amplifier 725, a second switch 730, an Rx signal generator 740, a controller 750, and a Tx signal generator 760.

The first switch 710, the signal converter 720, the frequency amplifier 725, the second switch 730, the Rx signal generator 740, the controller 750, and the Tx signal generator 760 as shown in FIG. 7 may respectively be substantially the same as or similar to the first switch 610, the signal converter 630, the frequency amplifier 635, the third switch 640, the Rx signal generator 650, the controller 660, and the Tx signal generator 670 as shown in FIG. 6. Accordingly, additional descriptions thereof will be omitted herein.

The transceiver 705 of FIG. 7 may be a dual-band antenna to perform dual-resonance of a Low Band (LB) and a High Band (HB). In a reception mode, the first switch 710 may transfer a signal received through the transceiver 705 to the Rx signal generator 740. In the transmission mode, the first switch 710 may transmit a transmission signal generated by the Tx signal generator 760 to at least one slave device through the transceiver 705 via the LB and the HB.

If the above-described DS-UWB terminal devices 100 to 700 are operated in the reception mode, an external device may periodically transmit a pilot signal to the DS-UWB terminal devices 100 to 700, before transmitting a signal in a low-frequency band (namely, a low-frequency reception signal) and a signal in a high-frequency band (namely, a high-frequency reception signal). Here, the pilot signal may include information used to determine whether a signal to be transmitted by a slave device is in a low-frequency band or a high-frequency band, and identification (ID) and location information of the slave device.

The DS-UWB terminal devices 100 to 700 may perform time-sharing to determine which one of the low-frequency reception signal and the high-frequency reception signal is currently received. Specifically, each of the DS-UWB terminal devices 100 to 700 may periodically monitor the low-frequency transceiver and the high-frequency transceiver in an alternating manner, and may detect a frequency band corresponding to the external device. Also, the DS-UWB terminal devices 100 to 700 may demodulate a signal of the detected frequency band, may detect a pilot signal, and may determine whether the detected frequency band is a low-frequency band or a high-frequency band.

If a type of the external device and a type of the frequency band are determined based on the pilot signal, the DS-UWB terminal devices 100 to 700 may transmit an acknowledgement message to the external device. For example, if a low-frequency reception signal is currently received, the DS-UWB terminal device 400 may control the third switch 425 to connect to the first switch 410. If a high-frequency reception signal is being received, the DS-UWB terminal device 400 may control the third switch 425 to connect to the second switch 420. Accordingly, the wideband reception filter 451 may identify which one of the low-frequency reception signal and the high-frequency reception signal is received through the third switch 425. After receiving the acknowledgement message, the external device may transmit the low-frequency reception signal and the high-frequency reception signal to the DS-UWB terminal device 400. In other words, the external device may be any device enabling simultaneous transmission of signals to the two frequency bands using a DS-UWB scheme, for example, a slave device, such as display device, a speaker, and the like.

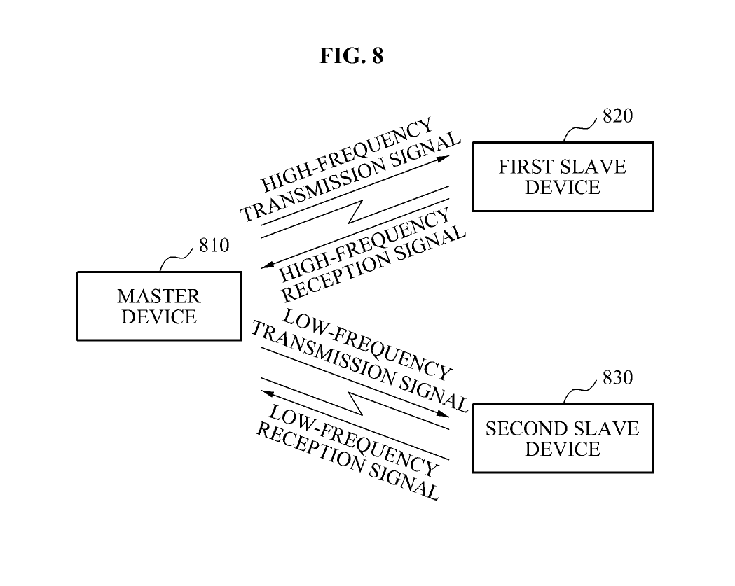

FIG. 8 is a block diagram of a DS-UWB system according to an exemplary embodiment of the present invention. Referring to FIG. 8, the DS-UWB system may include a master device 810, and a plurality of slave devices, namely, a first slave device 820 and a second slave device 830.

In the reception mode of the master device 810, the master device 810 may simultaneously or sequentially receive a low-frequency reception signal transmitted through a low-frequency band and a high-frequency reception signal transmitted through a high-frequency band, and the master device 810 may process the received signals. The master device 810 may be, for example, one of the DS-UWB terminal devices 100 to 700 described above with reference to FIGS. 1 to 7.

The first slave device 820 and the second slave device 830 may transmit to the master device 810 the high-frequency reception signal and the low-frequency reception signal through the high-frequency band and the low-frequency band, respectively. Specifically, the first slave device 820 may transmit the high-frequency reception signal to the master device 810 through the high-frequency band, and the second slave device 830 may transmit the low-frequency reception signal to the master device 810 through the low-frequency band. The first slave device 820 and the second slave device 830 may be, for example, at least one of the slave devices described above with reference to FIGS. 1 to 7. Also, the DS-UWB system of FIG. 8 may include at least two first slave devices 820 and/or at least two second slave devices 830.

In the transmission mode of the master device 810, the master device 810 may simultaneously or sequentially transmit a high-frequency transmission signal and a low-frequency transmission signal to the first slave device 820 and the second slave device 830 through the high-frequency band and the low-frequency band, respectively.

The low-frequency reception signal or the low-frequency transmission signal in the low-frequency band may include, for example, an audio signal. The high-frequency reception signal or the high-frequency transmission signal in the high-frequency band may include, for example, a video signal.

Also, the master device 810 may be a mobile device, for example, a mobile phone or a laptop. The first slave device 820 and the second slave device 830 may be any devices enabling DS-UWB communication with the master device 810, for example, another mobile device, such as, a speaker, a headset, and/or a display device.

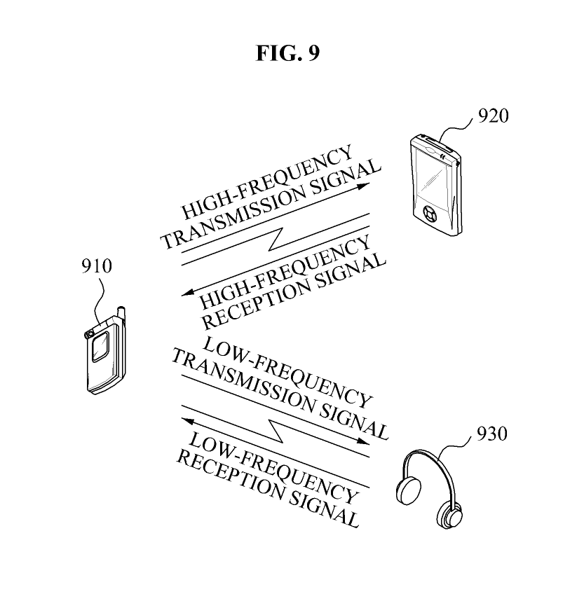

FIGS. 9 to 11 illustrate examples of DS-UWB systems according to exemplary embodiments of the present invention. Referring to FIG. 9, a mobile phone 910 may be a master device, and a display device 920 and a headset 930 may be slave devices. The mobile phone 910 may transmit a video signal to the display device 920 through the high-frequency band using a DS-UWB scheme, and may transmit an audio signal to the headset 930 through the low-frequency band using the DS-UWB scheme.

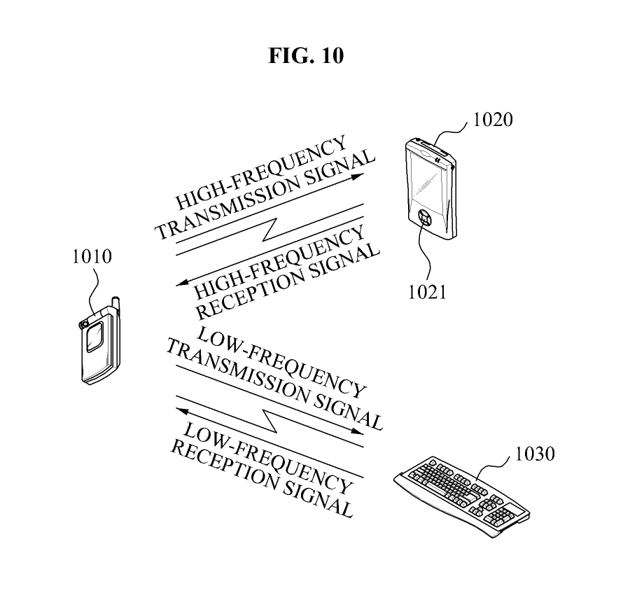

Referring to FIG. 10, a mobile phone 1010 may be a master device, and an LCD device 1020 and a keypad module 1030 may be slave devices. Here, the LCD device 1020 may have a speaker 1021. The mobile phone 1010 may transmit a video signal to the LCD device 1020 through the high-frequency band, and may input message data to the keypad module 1030 through the low-frequency band.

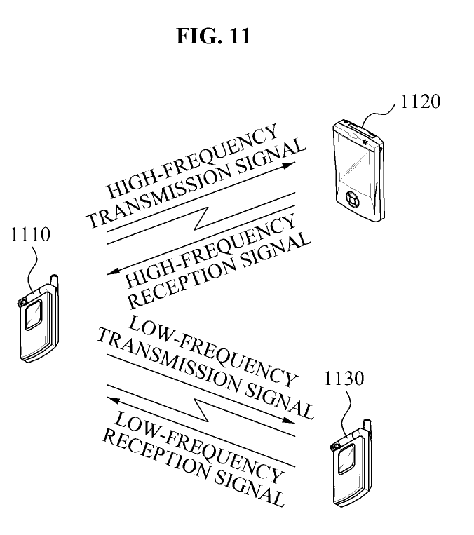

Referring to FIG. 11, a first mobile phone 1110 may be a master device, and a second mobile phone 1120 and a third mobile phone 1130 may be slave devices. The first mobile phone 1110 may transmit telephone conversation audio data to the third mobile phone 1130 through the low-frequency band, and may receive a video signal from the second mobile phone 1120 through the high-frequency band.

According to an exemplary embodiment of the present invention, if a Global Positioning System (GPS) function is not provided by a mobile phone as a master device, the mobile phone may be communicably connected to another mobile phone with the GPS function to receive map data from the other mobile phone through a high-frequency band, and to transmit a requested signal to the other mobile phone through a low-frequency band.

The methods according to exemplary embodiments of the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A Direct-Sequence Ultra-Wideband (DS-UWB) terminal device, comprising:
an Rx signal generator to generate a low-frequency reception signal and a high-frequency reception signal from a reception signal received through a UWB transceiver;
a signal processor to process the generated low-frequency reception signal and the generated high-frequency reception signal, and to output a transmission signal; and
a Tx signal generator to convert the transmission signal output from the signal processor and to generate a low-frequency transmission signal and a high-frequency transmission signal,
wherein the UWB transceiver transmits the generated low-frequency transmission signal or the generated high-frequency transmission signal through one of a low-frequency transmission band and a high-frequency transmission band.

2. The terminal device of claim 1, wherein the Rx signal generator comprises:
an Rx low-frequency signal generator to generate the low-frequency reception signal; and
an Rx high-frequency signal generator to generate the high-frequency reception signal.

3. The terminal device of claim 2, wherein the Rx low-frequency signal generator comprises:
a low-frequency filter to pass the low-frequency reception signal from the received reception signal;
a first amplifier to amplify the filtered low-frequency reception signal;
a first multiplier to multiply the amplified low-frequency reception signal by a weight and to convert the amplified low-frequency reception signal to a signal of a set frequency band; and
a first Automatic Gain Controller (AGC) to increase an amplification rate of the converted signal.

4. The terminal device of claim 2, wherein the Rx high-frequency signal generator comprises:
a high-frequency filter to pass the high-frequency reception signal from the received reception signal;
a second amplifier to amplify the filtered high-frequency reception signal;
a second multiplier to multiply the amplified high-frequency reception signal by a weight and to convert the amplified high-frequency reception signal to a signal of a set frequency band; and
a second AGC to increase an amplification rate of the converted signal.

5. The terminal device of claim 1, wherein the Tx signal generator comprises:
a Tx low-frequency signal generator to generate the low-frequency transmission signal;
a Tx high-frequency signal generator to generate the high-frequency transmission signal;
an adder to add the generated low-frequency transmission signal and the generated high-frequency transmission signal; and
a filter to pass a signal of an output frequency band from the added low-frequency transmission signal and high-frequency transmission signal.

6. The terminal device of claim 1, wherein the UWB transceiver comprises:
a low-frequency UWB transceiver to transceive a signal of a low-frequency band; and
a high-frequency UWB transceiver to transceive a signal of a high-frequency band.

7. The terminal device of claim 6, wherein the Rx signal generator comprises:
an Rx low-frequency signal generator to pass the low-frequency reception signal from a signal received through the low-frequency UWB transceiver, and to amplify the filtered low-frequency reception signal;
an Rx high-frequency signal generator to pass the high-frequency reception signal from a signal received through the high-frequency UWB transceiver, and to amplify the filtered high-frequency reception signal;
an adder to add the amplified low-frequency reception signal and the amplified high-frequency reception signal;
a first multiplier to multiply a signal output from the adder by a weight and to convert the signal output from the adder to a signal of a set frequency band; and
an AGC to increase an amplification rate of the converted signal.

8. The terminal device of claim 6, wherein the Rx signal generator comprises:
a wideband reception filter to pass the low-frequency reception signal and the high-frequency reception signal from signals received respectively through the low-frequency UWB transceiver and the high-frequency UWB transceiver;
a first multiplier to respectively multiply the filtered low-frequency reception signal and the filtered high-frequency reception signal by a weight, and to convert the filtered low-frequency reception signal and the filtered high-frequency reception signal to a signal of a set frequency band; and
an AGC to increase an amplification rate of the converted signal.

9. The terminal device of claim 7, wherein the Tx signal generator comprises:
a second multiplier to demultiplex the transmission signal and to output the low-frequency transmission signal and the high-frequency transmission signal;
a Tx low-frequency signal generator to temporarily store the output low-frequency transmission signal and to pass a signal of an output low-frequency band from the low-frequency transmission signal; and
a Tx high-frequency signal generator to pass a signal of an output high-frequency band from the output high-frequency transmission signal,
wherein the low-frequency UWB transceiver and the high-frequency UWB transceiver transmit signals output from the Tx low-frequency signal generator and the Tx high-frequency signal generator, respectively.

10. The terminal device of claim 7, wherein the Tx signal generator comprises:
a second multiplier to multiply the transmission signal by a weight; and
a wideband transmission filter to pass the weighted transmission signal, and to output a signal of an output low-frequency band and a signal of an output high-frequency band,
wherein the low-frequency UWB transceiver and the high-frequency UWB transceiver transmit the signals output from the wideband transmission filter, respectively.

11. The terminal device of claim 10, further comprising:
a controller to add data or a packet to a termination signal of the output low-frequency band, the data or the packet identifying the termination signal.

12. The terminal device of claim 6, wherein the Rx signal generator comprises:
a variable reception filter to variably pass a signal received through the low-frequency UWB transceiver and a signal received through the high-frequency UWB transceiver, and to output the low-frequency reception signal and the high-frequency reception signal;
an amplifier to amplify the filtered signal;
a multiplier to multiply the amplified signal by a weight and to convert the amplified signal to a signal of a set frequency band; and
an AGC to increase an amplification rate of the converted signal.

13. The terminal device of claim 1, wherein the Rx signal generator comprises:
a variable reception filter to variably pass a signal received through the UWB transceiver, and to output the low-frequency reception signal or the high-frequency reception signal;
an amplifier to amplify the filtered signal;
a multiplier to multiply the amplified signal by a weight and to convert the amplified signal to a signal of a set frequency band; and
an AGC to increase an amplification rate of the converted signal.

14. The terminal device of claim 13, further comprising:
a controller to periodically perform time-sharing of the low-frequency band and the high-frequency band so that the variable reception filter periodically outputs the low-frequency reception signal or the high-frequency reception signal.

15. The terminal device of claim 13, wherein the Tx signal generator comprises:
a variable amplifier to variably amplify the transmission signal and to output the low-frequency transmission signal or the high-frequency transmission signal; and
a variable transmission filter to pass a transmission signal of an output low-frequency band or a transmission signal of an output high-frequency band from the output low-frequency transmission signal or high-frequency transmission signal.

16. The terminal device of claim 15, further comprising:
a controller to add data or a packet to a termination signal of the output low-frequency band, the data or the packet identifying the termination signal.

17. A Direct-Sequence Ultra-Wideband (DS-UWB) system, comprising:
a master device to simultaneously or sequentially receive a low-frequency reception signal transmitted through a low-frequency band and a high-frequency reception signal transmitted through a high-frequency band if the master device is in a reception mode; and
at least one slave device to transmit to the master device at least one of the low-frequency reception signal and the high-frequency reception signal through the low-frequency band and the high-frequency band, respectively.

18. The system of claim 17, wherein, in a transmission mode, the master device simultaneously or sequentially transmits, to the at least one slave device, a low-frequency transmission signal and a high-frequency transmission signal through the low-frequency band and the high-frequency band, respectively.

19. The system of claim 17, wherein the low-frequency reception signal or the low-frequency transmission signal comprises an audio signal, and the high-frequency reception signal or the high-frequency transmission signal comprises a video signal.

20. The system of claim 17, wherein the master device comprises a first mobile terminal, and the at least one slave device comprises at least one of a second mobile terminal, a speaker, a headset, and a display device, the second mobile terminal, the speaker, the headset, and the display device in DS-UWB communication with the master device.
